(19) United States
(12) Patent Application Publication
(10) Pub. No.: US 2008/0285989 A1
(43) Pub. Date: Nov. 20, 2008

(54) IMAGE FORMING APPARATUS

(75) Inventor: Masataka YAGI, Okazaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/053,313

(22) Filed: Mar. 21, 2008

(30) Foreign Application Priority Data
May 16, 2007 (JP) 2007-130391

(51) Int. Cl. G03G 15/00; G03G 15/16

(52) U.S. Cl. 399/44; 399/66; 399/45

(57) ABSTRACT

An image forming apparatus has a transfer belt and a plural number of image forming units. The transfer belt has a sucking/feeding surface for sucking and feeding a sheet of transfer medium, and the sucking/feeding surface faces downward slanting from a vertical direction. The plural number of image forming units face the sucking/feeding surface of the transfer belt, and are arranged side by side along the transfer belt rotating direction. The transfer members are located inside a loop of the transfer belt and are pressed against a surface of the transfer belt on the reverse of the sucking/feeding surface in positions opposite photosensitive drums via the transfer belt. The transfer members apply a charge of a polarity opposite to that of toner to the transfer medium via the transfer belt. The transfer members are made of a conductive material.

This application is based on Japanese application No. 2007-130391 filed on May 16, 2007, the content of which is incorporated herewith by reference.

### BACKGROUND OF THE INVENTION

1. Field of the Invention

The present invention relates to an image forming apparatus, and more particularly to an image forming apparatus which forms a color toner image by electrophotography.

2. Description of Related Art

Conventionally, a tandem type is well known as a color image forming apparatus (a copying machine, a printer or the like) which forms a color image by electrophotography. In the image forming apparatus of a tandem type, a Y (yellow) image forming unit, a M (magenta) image forming unit, a C (cyan) image forming unit and a K (black) image forming unit are arranged side by side, and toner images of the respective colors formed on respective photosensitive drums in the image forming units are combined with one another. Further, image forming apparatuses of the tandem type are generally classified into an indirect transfer type and a direct transfer type. In the indirect transfer type, toner images are transferred onto an intermediate transfer belt (first transfer) and then transferred onto a sheet of transfer medium such as paper (second transfer). In the direct transfer type, while a sheet of transfer medium such as paper sucked on a transfer belt is being fed, toner images are transferred onto the transfer medium.

JP2000-137364A and JP2003-345101A disclose tandem type image forming apparatuses of the direct transfer type. In an image forming apparatus disclosed by JP2000-137364A, an endless rotary transfer belt has a sucking/feeding upper surface, and four image forming units are arranged side by side above the transfer belt facing the sucking/feeding surface of the transfer belt.

In the structure, the image forming units are positioned above the transfer belt. If a jam of transfer medium occurs during transfer of toner images, in order to open the transport path of the transfer medium, the transfer belt must be moved because it is impossible to move the large and heavy image forming units. However, because the transfer belt is located under the image forming units, the transport path cannot be open wide, and the user must bend to remove the jammed transfer medium from the transport path. Thus, in the image forming apparatus of the structure, it is hard to manage a jam of transfer medium.

In the direct transfer type, generally, rubber rollers are used as transfer members for applying a transfer charge of a polarity opposite to that of the toner to the transfer medium via the transfer belt. Each of the rubber roller has a roller of urethane foam with a resistance of 1×10⁶Ω or more fitted to a metal shaft. Therefore, the rubber rollers are costly. Also, the rubber rollers vary in electric resistance, and it is necessary to provide high voltage sources for the individual rubber rollers so as to adjust the voltages impressed on the individual rubber rollers. Thus, the power source section is costly.

### SUMMARY OF THE INVENTION

A first object of the present invention is to provide a less costly image forming apparatus of a tandem type and a direct transfer type wherein a jam can be managed easily.

A second object of the present invention is to provide an image forming apparatus wherein feeding of a sheet of transfer medium is highly stable so that dislocations of color images can be prevented.

In order to achieve the first object, the present invention provides an image forming apparatus comprising: a transfer belt which is driven to rotate at a specified speed and which has a sucking/feeding surface for sucking and feeding a sheet of transfer medium, the sucking/feeding surface slanting from a vertical direction to face downward; a plural number of image forming units facing the sucking/feeding surface of the transfer belt, the image forming units being arranged side by side along a transfer belt rotating direction and; a plural number of transfer members which are pressed against the transfer belt on a reverse of the sucking/feeding surface, the transfer members being located opposite respective photosensitive drums included in the image forming units and applying a charge of a polarity opposite to that of toner to the sheet of transfer medium via the transfer belt. In the image forming apparatus, at least one of the transfer members is made of a conductive material and is located upstream or downstream in a transfer belt rotating direction from a nip portion between the opposing photosensitive drum and the transfer belt.

In the image forming apparatus according to the present invention, the sucking/feeding surface of the transfer belt slants from the vertical direction to face downward, and a plural number of image forming units face the sucking/feeding surface of the transfer belt and are arranged side by side in the transfer belt rotating direction. In this structure, the transfer belt can be pulled upward, and thereby, the transport path of the transfer medium can be open wide. Therefore, when a jam of transfer medium occurs, the jammed sheet can be removed easily. Also, at least one of the transfer members is made of a conductive material. For example, the conductive transfer member may be a metal roller, which is inexpensive.

The conductive transfer member has an electric resistance of almost zero. Therefore, when two or more conductive transfer members are provided, it is not necessary to adjust bias voltages impressed on the individual transfer members, and it is possible to apply a bias voltage to the conductive transfer members from one high-voltage source. Thus, the power section is not costly.

The conductive transfer member may be a roller of conductive metal or conductive resin or may be a conductive film which is in contact with the transfer belt.

As mentioned, in the image forming apparatus, a sheet of transfer medium is fed by the sucking/feeding surface (facing downward) of the transfer belt, and at least one of the transfer members is made of a conductive material. In this structure, the sheet of transfer medium fed by the transfer belt is apt to peel down from the sucking/feeding surface due to the gravity, and in some cases, the sucking/feeding performance of the transfer belt may be bad. Also, it is necessary to locate the conductive transfer member upstream or downstream in the transfer belt rotating direction from the nip portion between the opposing photosensitive drum and the transfer belt so that the transfer member can perform stable discharge. Thereby, the sucking/feeding surface of the transfer belt is wavy. If the humidity is high and/or if the fed transfer medium is thick paper, the feeding of transfer medium may not be performed well.

When the feeding performance of the transfer belt is bad, the edge of the sheet of transfer medium may peel off from the sucking/feeding surface and may hit upon the photosensitive drum. Then, on the photosensitive drum, a dislocation may occur during optical writing of an image, which results in a color dislocation in the formed color image.

In order to avoid this trouble, preferably, the image forming apparatus according to the present invention further comprises an adjusting mechanism for adjusting a wind of the transfer belt around the conductive transfer member or the photosensitive drum opposite the conductive transfer member; and a control section for controlling the adjusting mechanism to adjust the wind of the transfer belt in accordance with at least an environmental condition or a kind of transfer medium.

In a case wherein the feeding performance may be bad, for example, when the humidity is high or when the fed transfer medium is thick paper, the wind of the transfer belt around the conductive transfer member or the photosensitive drum opposite the conductive transfer member is lightened, and thereby, the transfer belt moves straight and keeps stable feeding performance. Consequently, the trouble such as a color dislocation can be avoided.

More specifically, the image forming apparatus may comprise a pressure adjusting mechanism for adjusting a pressure of the conductive transfer member onto the transfer belt; and a control section for controlling the pressure adjusting mechanism to adjust the pressure of the conductive transfer member in accordance with at least an environmental condition or a kind of transfer medium. The pressure adjusting mechanism may comprise a spring member for elastically pushing the conductive transfer member and an adjusting member for adjusting a spring force of the spring member. The pressure adjusting mechanism may adjust the pressure of the conductive transfer member onto the transfer belt to a plural number of levels. Also, the pressure adjusting mechanism may be capable of moving the conductive transfer member to a position to make the transfer belt separate from the photosensitive drum located opposite the conductive transfer member.

Alternatively, the image forming apparatus according to the present invention may comprise: a tension adjusting mechanism for adjusting a tension of the transfer belt; and a control section for controlling the tension adjusting mechanism to adjust the tension of the transfer belt in accordance with at least an environmental condition or a kind of transfer medium. In the image forming apparatus, the tension adjusting mechanism may comprise a spring member for elastically pushing a roller holding the transfer belt and an adjusting member for adjusting a spring force of the spring member.

### BRIEF DESCRIPTION OF THE DRAWINGS

These and other objects and features of the present invention will be apparent from the following description with reference to the accompanying drawings, in which:

FIG. 1 is a schematic view of an image forming apparatus according to a first embodiment of the present invention;

FIG. 2 is a front view of a first exemplary transfer member;

FIG. 3 is a sectional view of a second exemplary transfer member;

FIG. 4 is a sectional view of a third exemplary transfer member;

FIG. 5 is a schematic view of an image forming apparatus provided with fourth exemplary transfer members;

FIG. 6 is an illustration showing feeding of a transfer medium in a bad state;

FIG. 7 is an illustration showing a basic structure of an adjustor for adjusting pressing forces of the transfer members onto a transfer belt;

FIG. 8 is a schematic view of an image forming apparatus according to a second embodiment of the present invention;

FIG. 9 is a schematic view of an image forming apparatus according to a third embodiment of the present invention;

FIG. 10 is a schematic view of an image forming apparatus according to a fourth embodiment of the present invention;

FIG. 11 is a schematic view of an image forming apparatus according to a fifth embodiment of the present invention; and

FIG. 12 is a schematic view of an image forming apparatus according to a sixth embodiment of the present invention.

### DETAILED DESCRIPTION OF THE PREFERRED EMBODIMENTS

Preferred embodiments of the present invention are hereinafter described with reference to the accompanying drawings. In the embodiments below, same parts and members are provided with same reference symbols, and repetitious descriptions are omitted.

### First Embodiment

### See FIG. 1

FIG. 1 shows an image forming apparatus according to a first embodiment of the present invention. The image forming apparatus is of a tandem type and a direct transfer type which forms a color toner image by conventional electrophotography. Specifically, the image forming apparatus has a transfer belt 1 wound and held endlessly around a driving roller 2 and a driven roller 3, and four image forming units 10 (10Y, 10M, 10C and 10K) which form four toner images of four colors (Y, M, C and K) respectively.

The transfer belt 1 is driven by the driving roller 2 to rotate in a direction “A” at a constant velocity. Meanwhile, a transfer medium M such as paper is fed in a direction “B” sheet by sheet, and each sheet of transfer medium is sucked and held on a lower surface of the transfer belt 1 by electrostatic applied from the suction roller 4 and fed in the direction “A”. In the following paragraphs, the lower surface of the transfer belt 1 is referred to as a sucking/feeding surface 1a. The driven roller 3 is pulled elastically by the coil spring 5, and therefore, the transfer belt 1 has a specified tensile strength.

Each of the image forming units 10 comprises a photosensitive drum 11 and other elements (not shown), such as a charger, a developing device, an exposure unit (an optical scanning unit), etc. a Y toner image, an M toner image, a C toner image and a K toner image are formed on the respective photosensitive drums 11. The toner image forming process is well known, and a description thereof is omitted.

On the reverse side of the sucking/feeding surface 1a of the transfer belt 1, transfer members 15 are elastically pressed against the individual photosensitive drums 11. The transfer members 15 are made of a conductive material, which will be described later, and are positioned slightly downstream from the respective nip portions between the individual photosensitive drums 11 and the transfer belt 1 in the belt rotating direction “A”. A high-voltage source 20 impresses a specified transfer bias voltage on the transfer members 15.

While a sheet of transfer medium sucked and fed on the sucking/feeding surface 1a of the transfer belt 1 is passing by the photosensitive drums 11, the transfer members 15 apply a charge of a polarity opposite to that of the toner to the sheet of transfer medium, and thereby, the toner images formed on the photosensitive drums 11 are transferred onto the sheet of transfer medium. Thus, toner images formed on the photosensitive drums 11 are transferred onto a sheet of transfer medium and combined thereon, and then, the combined toner images are heated and fixed on the sheet by a fixing unit 21.

The transfer belt 1, the rollers 2, 3 and the transfer members 15 are fitted to a frame (not shown) and constructed as a transfer unit. The transfer unit can be pivoted in a direction “C”, and a user can open the transport path of transfer medium wide by pivoting the transfer unit in the direction “C”. Therefore, if a jam of transfer medium occurs during transfer of toner images, a user can open the transport path by pivoting the transfer unit in the direction “C” and can remove the jammed sheet easily.

The transfer members 15 are of a conductive material. For example, by using metal rollers as the transfer members 15, the transfer members 15 are not costly. Also, because the transfer members 15 have electric resistances of almost zero, it is not necessary to adjust the voltages impressed on the transfer members 15. Therefore, it is possible to use only one high-voltage source to impress a specified voltage on all the transfer members 15, and the power source section is not costly.

### Specific Examples of Transfer Members

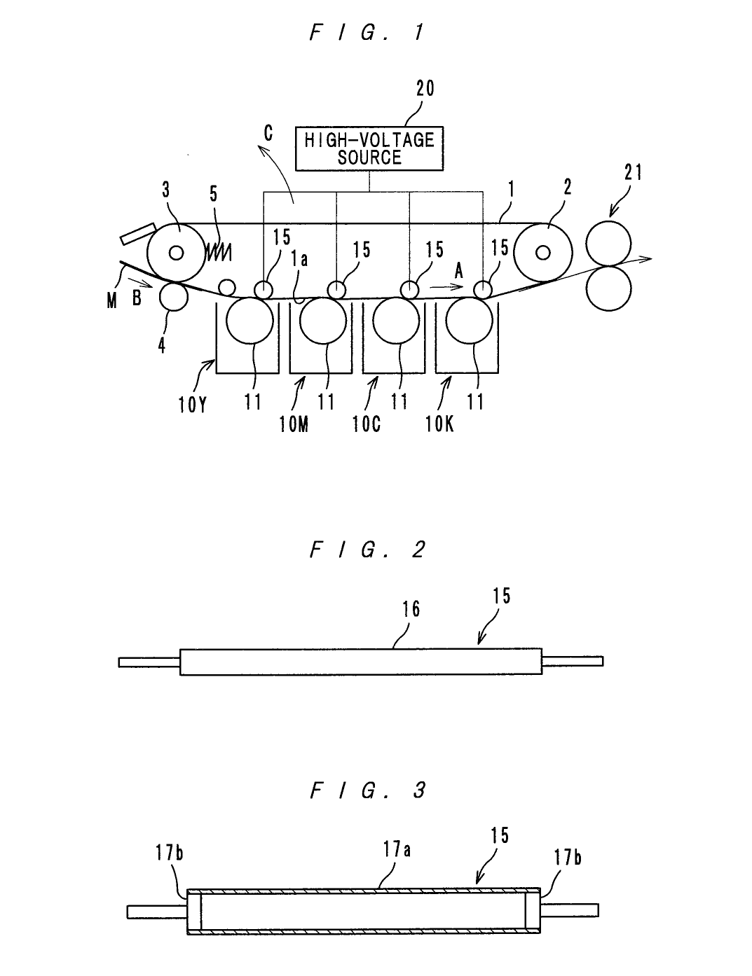

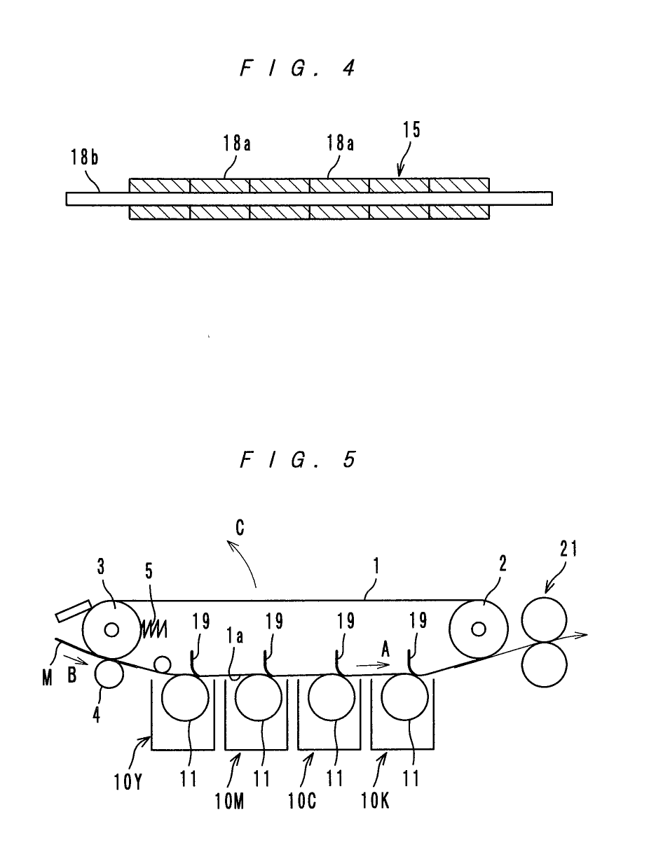

### See FIGS. 2-5

FIG. 2 shows a first exemplary transfer member. The first exemplary transfer member is a metal shaft 16, which can be produced at low cost. The metal shaft 16 is a roller of preferably stainless or aluminum. In view of strength and cost, preferably, the shaft is solid and is thin, for example, has a diameter of approximately 8 mm. If the transfer member is formed as a metal pipe, the weight can be reduced.

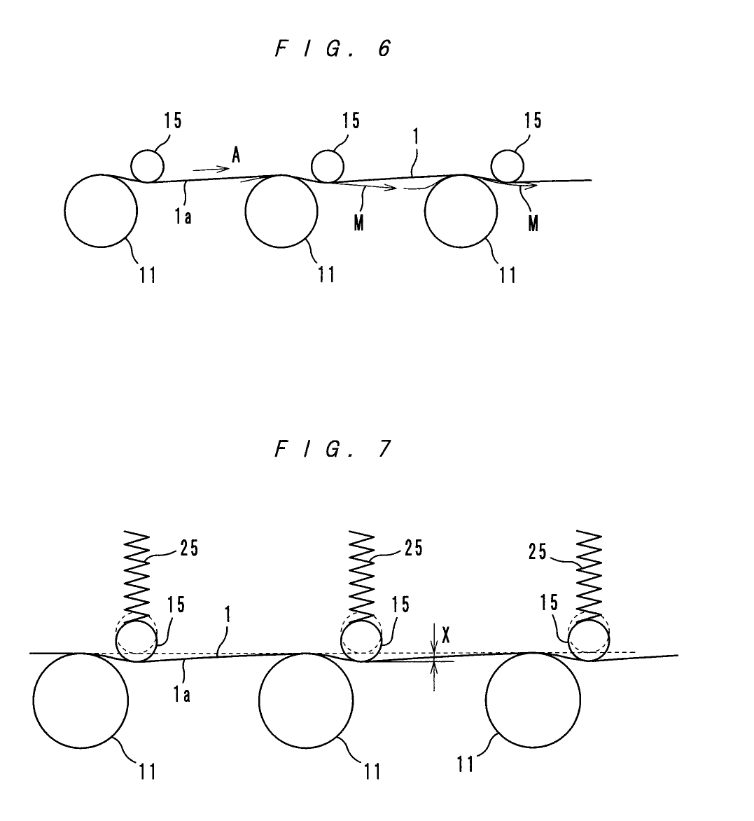

However, when thin transfer rollers are used, the transfer belt 1 may have creeps at the positions to wind around the transfer rollers, and the creeps may cause maltransfer (image noise). By using thick rollers with a large diameter as shown by FIG. 3 or 4, the trouble can be avoided.

FIG. 3 shows a second exemplary transfer member. The second exemplary transfer member is a metal pipe 17a with flanges 17b at both ends. The diameter of the pipe 17a is 12 mm or more. FIG. 4 shows a third exemplary transfer member. The third exemplary transfer member is a roller composed of a plural number of conductive resin (for example, conductive polyacetar) sleeves 18a covered on a metal shaft 18b. The diameter of the sleeves 18a is 12 mm or more. If the conductive resin sleeves 18a have electric resistances of not more than 1 kΩ, the variances in electric resistance of the sleeves 18a composing a transfer member can be ignored, and further, the variances in electric resistance of the transfer members 15 located opposite the respective photosensitive drums 11 can be ignored. In this case, therefore, by impressing a specified voltage on the transfer members 15 from the high-voltage source 20, all the transfer members 15 can have the same charge.

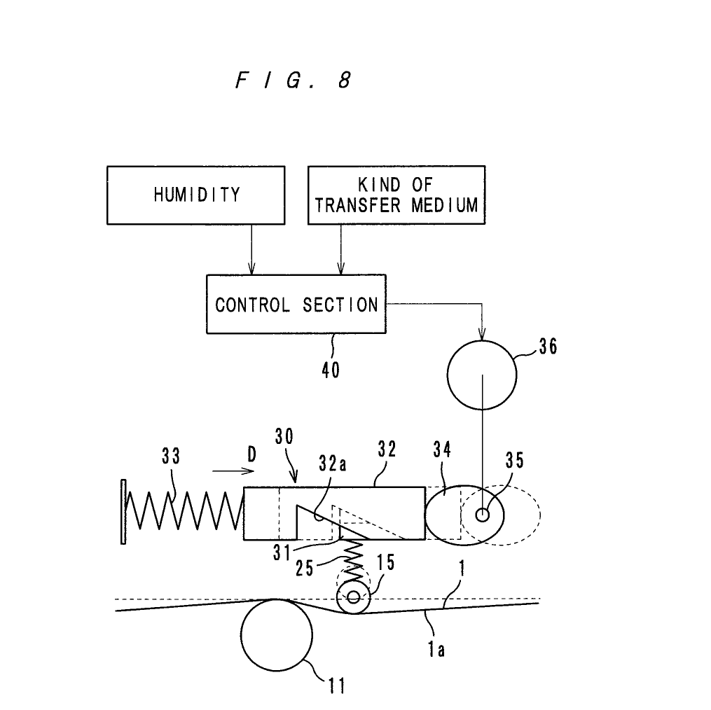

FIG. 5 shows an image forming apparatus provided with fourth exemplary transfer members. The transfer members shown in FIG. 5 are conductive films 19, for example, films of fluororesin or polyamide resin with a surface resistivity of approximately 100Ω. Each of the films 19 is located downstream (ahead in the belt rotating direction “A”) from the nip portion between the corresponding photosensitive drum 11 and the transfer belt 1, and the end portion of the film is pressed against the transfer belt 1 on the reverse of the sucking/feeding surface 1a. Thereby, the transfer belt 1 is bent, and the individual photosensitive drums 11 are in contact with the transfer belt 1 in a range of 1 mm to 2 mm in the circumferential direction.

The conductive films 19 of fluororesin or the like are approximately 100 μm in thickness and are not rigid. Therefore, in order to bend the transfer belt 1 to attain an appropriate nip width, the films 19 must be backed up by polyphenylene sulfide resin or the like.

### Arrangement of Transfer Members and Stability of Feeding

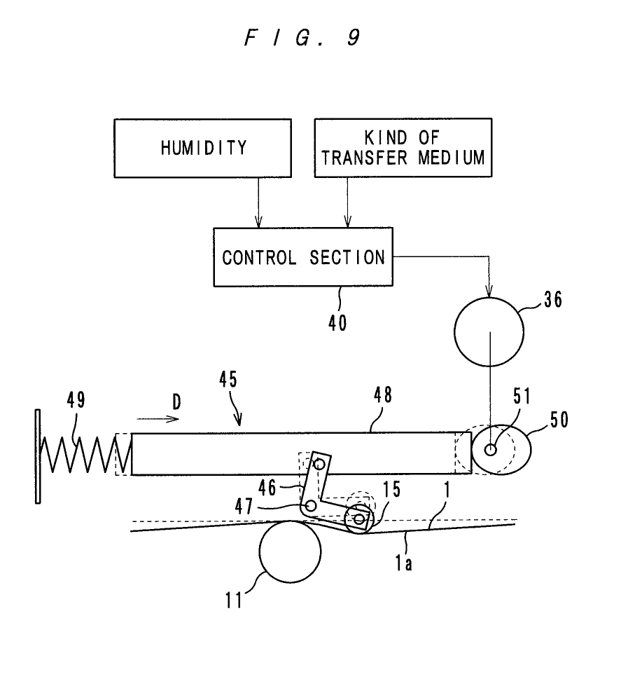

### See FIGS. 6 and 7

The transfer members 15 have small electric resistances and therefore form electric fields for transfer by using the electric resistance of the transfer belt 1, which is a semiconductor (the surface resistance of the transfer belt 1 is within a range approximately from 1×10⁸Ω to 1×10¹⁰Ω). Specifically, each of the transfer members 15 is located 2 mm to 6 mm downstream in the belt rotating direction from the nip portion between the corresponding photosensitive drum 11 and the transfer belt 1, and the transfer member 15 uses the electric resistance of the transfer belt 1 in the part from the nip portion and the location of the transfer member 15.

Each of the transfer members 15 may be located 2 mm to 6 mm upstream in the belt rotating direction from the nip portion between the corresponding photosensitive drum 11 and the transfer belt 1. In this case, however, discharge is likely to occur before transfer of a toner image, and the transfer member 15 may not give a full transfer performance.

When the transfer members 15 are of a conductive material as described above, as shown by FIG. 6, the transfer belt 1 must be pushed by the transfer members 15 downward by approximately 0.5 mm from the tangents at the top of the individual photosensitive drums 11. Thereby, the sucking/feeding surface 1a of the transfer belt 1 becomes wavy. The sucking/feeding surface 1a of the transfer belt 1 faces down, and a sheet of transfer medium M fed by the transfer belt 1 is pulled downward by the gravity. Therefore, if it is under high humidity of 85% or more, or if the transfer medium M is thick paper (dense paper such as a postcard or an envelope), the edge of the sheet of transfer medium M may peel off the sucking/feeding surface 1a of the transfer belt 1. Especially when it is under high temperature and high humidity (for example, not less than 30° C. and not less than 85%), it is highly possible that the transfer medium M may peel off the sucking/feeding surface 1a.

When a sheet of transfer medium M of which edge peels off the sucking/feeding surface 1a hits against the next photosensitive drum 11, a dislocation occurs during transfer of a toner image from the photosensitive drum 11, which results in a dislocation in a composite color image. Therefore, under conditions which may degrade feeding of transfer medium, preferably, the transfer belt 1 is kept in a condition to move as straight as possible, that is, the sucking/feeding surface 1a is kept as flat as possible.

Thus, when it is under high humidity or when the transfer medium M is thick paper, stable feeding can be achieved by making the sucking/feeding surface 1a as flat as possible. For this purpose, the image forming apparatus is provided with an adjustor for adjusting the winds of the transfer belt 1 around the photosensitive drums 11 or the transfer members 15 and a controller for commanding the adjustor to adjust the winds of the transfer belt 1 in accordance with at least the environmental conditions or the kind of transfer medium.

FIG. 7 shows a basic structure of the adjustor. Each of the transfer members 15 is pushed downward and pressed against the opposing photosensitive drum 11 by coil springs 25 provided at both ends (in an axial direction) of the transfer member 15. The pushing amount is denoted by “X”. When thin paper or ordinary paper is fed, the strength of the coil springs 25 is set to a comparatively large value (10N to 15N at one side) to achieve a pushing amount shown in FIG. 7 (X=0.5 mm). When feeding performance may be degraded, the strength of the coil springs 25 is reduced (3N to 5N at one side) to reduce the pushing amount (X=0.2 mm).

Table 1 below shows the relationship between the pushing amount X and the feeding performance. A circle shows good performance, and a cross shows poor feeding performance.

TABLE 1

| | Pushing Amount (mm) | | | | | | | | | | |
|---|---|---|---|---|---|---|---|---|---|---|---|
| | 0.0 | 0.1 | 0.2 | 0.3 | 0.4 | 0.5 | 0.6 | 0.7 | 0.8 | 0.9 | 1.0 |
| Thin Paper | ◯ | ◯ | ◯ | ◯ | ◯ | ◯ | ◯ | ◯ | ◯ | ◯ | ◯ |
| Ordinary Paper | ◯ | ◯ | ◯ | ◯ | ◯ | ◯ | ◯ | ◯ | ◯ | ◯ | ◯ |
| Thick Paper | ◯ | ◯ | ◯ | ◯ | X | X | X | X | X | X | X |
| Postcard | ◯ | ◯ | ◯ | ◯ | X | X | X | X | X | X | X |
| Envelope | ◯ | ◯ | ◯ | X | X | X | X | X | X | X | X |

In order to form a monochromatic image, only the image forming unit 10K for forming a black toner image is operated, and the other image forming units 10Y, 10M and 10C are not operated. In this case, the transfer members 15 provided for the image forming units 10Y, 10M and 10C do not need to press the transfer belt 1. Therefore, the strengths of the coil springs 25 attached to these transfer members 15 may be set to the minimum value so that the belt pushing amount X will be almost zero or so that the transfer belt 1 will separate from the photosensitive drums 11 of the three image forming units 10Y, 10M and 10C.

### Second Embodiment

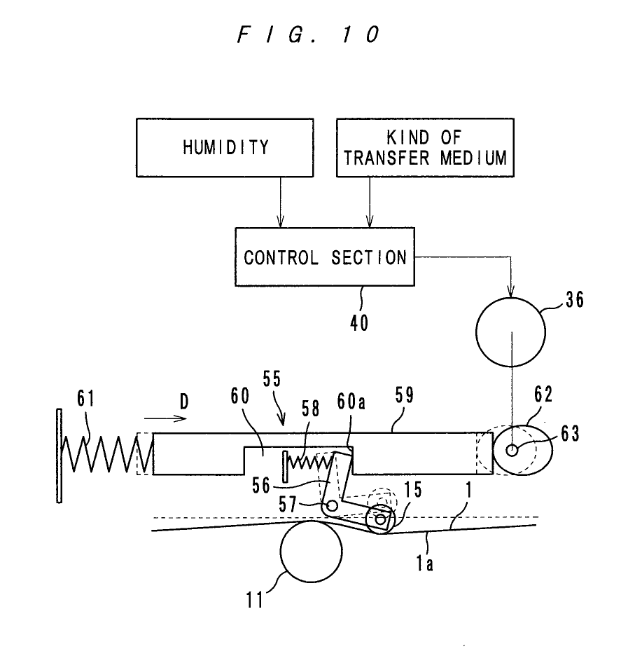

### See FIG. 8

FIG. 8 shows an image forming apparatus according to a second embodiment of the present invention. The image forming apparatus is basically of the same structure as the image forming apparatus according to the first embodiment. FIG. 8 is to show a specific mechanism for adjusting the pressures of the transfer members 15 onto the transfer belt 1. FIG. 8 shows only a pressure adjusting mechanism 30 connected to one of the coil springs 25 provided for one of the transfer members 15 opposing one of the image forming units. Although it is not shown, another pressure adjusting mechanism of the same structure is connected to the other coil spring 25 provided for the transfer member 15. Further, pressure adjusting mechanisms 30 of the same structure are provided also for the other transfer members 15 opposing the other image forming units.

One of the pressure adjusting mechanism 30 is described. A follower 31 is fitted to an upper end of the coil spring 25, which elastically pushes the transfer member 15, and is in contact with an inclined surface 32a of a slider 32. Also, a coil spring 33 is fitted to an end of the slider 32 and elastically pushes the slider 33 in a direction “D”, while the circumference of a cam 34 is in contact with the other end of the slider 32. The cam 34 is driven by a motor 36 to rotate on a shaft 35.

The motor 36 is controlled by a control section 40. The control section 40 receives information on the environmental conditions and information on the kind of transfer medium (thin paper, ordinary paper, thick paper, postcard, envelope, etc.) from sensors (not shown).

In the structure, when the cam 34 touches the slider 32 with the part of a larger diameter, the slider 32 moves in a direction opposite the arrow “D” against the power of the coil spring 33. Accordingly, the follower 31 comes down along the inclined surface 32a and compresses the coil spring 25, and the pushing force of the coil spring 25 on the transfer member 15 becomes larger. Consequently, the transfer belt 1 at this part is pressed against the photosensitive drum 11 with a necessary force.

Meanwhile, the control section 40 judges from the information on environmental conditions and the information on the kind of transfer medium whether the apparatus is under a condition which may degrade feeding of transfer medium. If the apparatus is under a condition which may degrade feeding of transfer medium, the control section 40 commands the motor 36 to rotate the cam 34 by 180 degrees. Thereby, the cam 34 touches the slider 32 with the part of a smaller diameter, and the slider 32 is moved in the direction “D” by the coil spring 33. Accordingly, the follower 31 comes up along the inclined surface 32a, and the pushing force of the coil spring 25 on the transfer member 15 becomes smaller. Consequently, the pressing force of the transfer member 15 against the photosensitive drum 11 becomes smaller.

By controlling the angle of rotation of the cam 34, the pressing force of the transfer member 15 can be adjusted with a plural number of steps.

### Third Embodiment

### See FIG. 9

FIG. 9 shows an image forming apparatus according to a third embodiment of the present invention. This image forming apparatus is basically of the same structure as the image forming apparatus according to the first embodiment. FIG. 9 is to show another specific mechanism for adjusting the pressures of the transfer members 15 onto the transfer belt 1. FIG. 9 shows only a pressure adjusting mechanism 45 provided for one of the transfer members 15 opposing one of the image forming units. However, one more pressure adjusting mechanism of the same structure is provided for the transfer member 15. Further, pressure adjusting mechanisms 45 of the same structure are provided for the other transfer members 15 opposing the other image forming units.

Both ends of a transfer member 15 are fitted to ends of dog-leg levers 46, and a pressure adjusting mechanism 45 is provided for each of the dog-leg levers 46. The lever 46 is pivoted on a shaft 47, and the other end of the lever 46 is connected to a slider 48. A coil spring 49 is fitted to an end of the slider 48 and elastically pushes the slider 48 in a direction “D”, and the circumference of a cam 50 is in contact with the other end of the slider 48. The cam 50 is driven by a motor 36 to rotate on a shaft 51. The motor 36 is controlled by a control section 40, and the structure and the operation of the control section 40 are the same as described in connection with the second embodiment.

In the structure, when the cam 50 touches the slider 48 with the part of a smaller diameter, the slider 48 is pushed by the coil spring 49 and moves in a direction “D”, and the lever 46 pivots clockwise on the shaft 47. Thereby, the pressure of the transfer member 15 onto the transfer belt 1 becomes large, and the transfer belt 1 at this part is pressed against the photosensitive drum 11 with a necessary force.

Meanwhile, the control section 40 judges from the information on environmental conditions and the information on the kind of transfer medium whether the apparatus is under a condition which may degrade feeding of transfer medium. If the apparatus is under a condition which may degrade feeding of transfer medium, the control section 40 commands the motor 36 to rotate the cam 50 by 180 degrees. Thereby, the cam 50 touches the slider 48 with the part of a larger diameter, and the slider 48 moves in an opposite direction to arrow “D” against the coil spring 49. Accordingly, the lever 46 pivots counterclockwise slightly on the shaft 47. Consequently, the pressing force of the transfer member 15 against the photosensitive drum 11 becomes smaller, and the pressure on the transfer belt 1 at this part becomes smaller.

In the third embodiment, by controlling the angle of rotation of the cam 50, the pressing force of the transfer member 15 can be adjusted by a plural number of steps.

### Fourth Embodiment

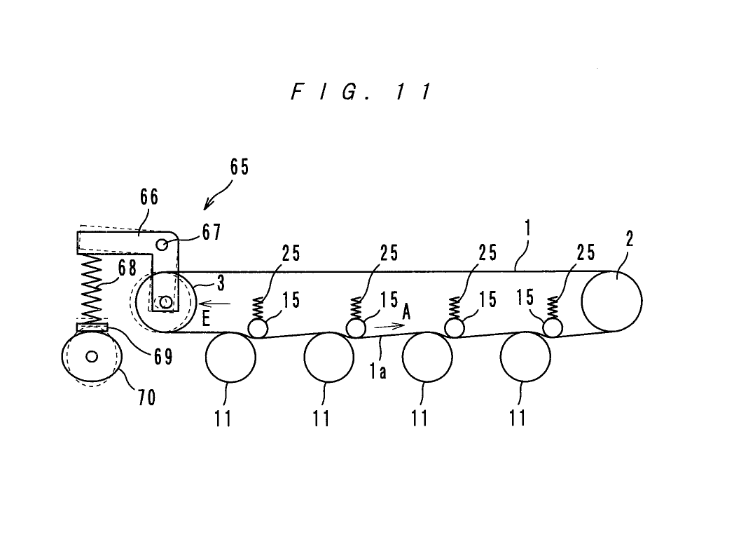

### See FIG. 10

FIG. 10 shows an image forming apparatus according to a fourth embodiment of the present invention. This image forming apparatus is basically of the same structure as the image forming apparatuses according to the second and the third embodiment. In the fourth embodiment, the image forming apparatus has pressure adjusting mechanisms 55 for adjusting the pressures of the transfer members 15 onto the transfer belt 1. The pressure adjusting mechanisms 55 permit the transfer belt 1 to separate from the photosensitive drums 11. Specifically, when only the image forming unit 10K operates to form a monochromatic image, the other image forming units 10Y, 10M and 10C do not operate, and in this case, it is preferred that the photosensitive drums 11 in the non-operating image forming units 10Y, 10M and 10C are away from the transfer belt 1.

Both ends of each transfer member 15 are fitted to ends of dog-leg levers 56, and a pressure adjusting mechanism 55 is provided for each of the dog-leg levers 56, which is pivoted on a shaft 57. A slider 59 is located above the dog-leg lever 56, and the slider 59 has a recess 60 on the surface facing the lever 56. The other end of the lever 56 is elastically pressed by a coil spring 58 against a wall 60a of the recess 60 made in the slider 59. An end of the slider 59 is elastically pushed in a direction “D” by a coil spring 61, and the circumference of a cam 62 is in contact with the other end of the slider 59. The cam 62 is driven by a motor 36 to rotate on a shaft 63. The motor 36 is controlled by the control section 40, of which structure and operation have been described in connection with the second embodiment. The control section 40 further controls the image forming units 10Y, 10M, 10C and 10K according to the image forming mode (a color image forming mode and a monochromatic image forming mode).

In the structure, when the cam 62 touches the slider 59 with a part of a smaller diameter, the slider 59 is pushed by the coil spring 61 and moves in the direction “D” and accordingly, the end of the lever 56 pressed against the wall 60a by the coil spring 58 moves in the direction “D”. Thereby, the lever 56 pivots clockwise on the shaft 57, and the pressure of the transfer member 15 onto the transfer belt 1 becomes larger. Consequently, the transfer belt 1 at this part is pressed against the opposing photosensitive drum 11 with a necessary force.

Meanwhile, the control section 40 judges from the information on environmental conditions and the information on the kind of transfer medium whether the apparatus is under a condition which may degrade feeding of transfer medium. If the apparatus is under a condition which may degrade feeding of transfer medium, the control section 40 commands the motor 36 to rotate the cam 62 by 90 degrees. Thereby, the cam 62 touches the slider 59 with the part of a medium diameter, and the slider 59 moves in an opposite direction to arrow “D” against the coil spring 61. Accordingly, the lever 56 pivots counterclockwise slightly on the shaft 57. Consequently, the pressing force of the transfer member 15 onto the transfer belt 1 becomes smaller, and the pressure of this part of the transfer belt 1 against the opposing photosensitive drum 11 becomes smaller.

In a monochromatic image forming mode, the cam 62 is rotated by further 90 degrees. Thereby, the cam 62 touches the slider 59 with the part of a larger diameter, and the slider 59 moves further in an opposite direction to arrow “D”, and accordingly, the lever 56 pivots counterclockwise further on the shaft 57. Consequently, the pressing force of the transfer member 15 onto the transfer belt 1 becomes smaller, and this part of the transfer belt 1 separate from the opposing photosensitive drum 11.

### Fifth Embodiment

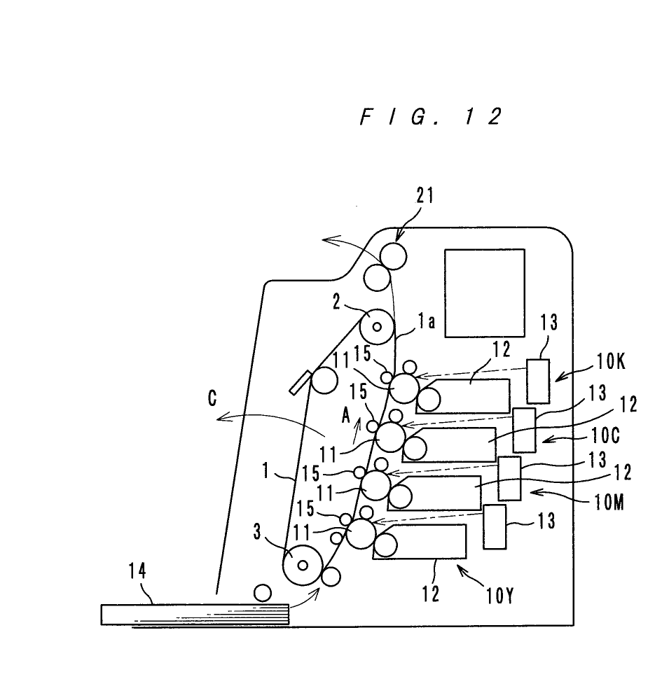

### See FIG. 11

FIG. 11 shows an image forming apparatus according to a fifth embodiment of the present invention. This image forming apparatus is basically of the same structure as the image forming apparatus according to the first embodiment. FIG. 11 is to show a tension adjusting mechanism 65 for adjusting the tension of the transfer belt 1 to adjust the pressing force of the transfer belt 1 onto the photosensitive drums 11.

The transfer members 15 are elastically pushed by coil springs 25 and are located inside a loop of the transfer belt 1 and pressed against the reverse side of the sucking/feeding surface 1a. The driven roller 3 holding the transfer belt 1 is fitted to an end of a dog-leg lever 66. The lever 66 is pivoted on a shaft 67, and the other end of the lever 66 is positioned on the upper end of a coil spring 68. The lower end of the coil spring 68 is in contact with the circumference of a cam 70 via a follower 69. The cam 70 is driven to rotate by a motor (not shown).

In the structure, when the cam 70 touches the follower 69 with a part of a smaller diameter, the pressing force of the coil spring 68 is smaller than the tension of the transfer belt 1, and the transfer belt 1 keeps its initial tension. In this state, the transfer members 15 press the transfer belt 1 by the pressing forces of the coil springs 25, and the transfer belt 1 is pushed onto the photosensitive members 11 by a specified amount.

When a condition which may degrade feeding of transfer medium occurs, for example, when humidity becomes higher or when thick paper is fed, the cam 70 is rotated by 90 degrees. Thereby, the follower 69 is pushed upward by a larger-diameter part of the cam 70, and the coil spring 68 is compressed. The force of the coil spring 68 at this time is larger than the initial tension of the transfer belt 1, and the lever 66 is pivoted clockwise slightly on the shaft 67. Accordingly, the driven roller 3 moves slightly in a direction “E”. Thereby, the tension of the transfer belt 1 becomes larger, and the transfer members 15 are moved upward slightly against the pressing forces of the coil spring 25. Consequently, the pressing force of the transfer belt 1 against the photosensitive drums 11 becomes smaller.

The image forming apparatus according to the fifth embodiment further has a control section as described in connection with the second to fourth embodiments.

### Sixth Embodiment

### See FIG. 12

FIG. 12 shows an image forming apparatus according to a sixth embodiment of the present invention. In this image forming apparatus, the transfer belt 1 extends almost vertically, and the sucking/feeding surface 1a slants slightly to the right from the vertical direction and faces downward. The transfer unit can be pivoted in a direction “C”, and the transport path can be wide open. Therefore, when a jam of transfer medium occurs, the transfer unit is pivoted in the direction “C”, and the jammed sheet can be removed easily. The transfer members 15 are made of a conductive material, and an adjusting mechanism for adjusting the pressures of the transfer members 15 onto the transfer belt 1 is provided although it is not shown.

In FIG. 12, the number 12 denotes a developing device, and the number 13 denotes a laser scanning unit for writing an image on the corresponding photosensitive drum 11. The number 14 denotes a cassette stored with transfer medium, and the transfer medium is fed out of the cassette 14 sheet by sheet.

### Other Embodiments

Image forming apparatuses according to the present invention are not limited to the embodiments above.

In order to achieve stable feeding of transfer medium, the image forming units including the photosensitive drums as well as the transfer members and the transfer belt may be moved. A color dislocation causing from degradation of feeding does not occur after the most downstream image forming unit, and therefore, the adjusting mechanism for the transfer member opposing the black image forming unit is not indispensable.

Although the present invention has been described in connection with the preferred embodiments above, it is to be noted that various changes and modifications are possible to those who are skilled in the art. Such changes and modification are to be understood as being within the scope of the present invention.

What is claimed is:

1. An image forming apparatus comprising:
a transfer belt which is driven to rotate at a specified speed and which has a sucking/feeding surface for sucking and feeding a sheet of transfer medium, the sucking/feeding surface slanting from a vertical direction to face downward;
a plural number of image forming units facing the sucking/feeding surface of the transfer belt, the image forming units being arranged side by side along a transfer belt rotating direction and;
a plural number of transfer members which are pressed against the transfer belt on a reverse of the sucking/feeding surface, the transfer members being located opposite respective photosensitive drums included in the image forming units and applying a charge of a polarity opposite to that of toner to the sheet of transfer medium via the transfer belt,
wherein, at least one of the transfer members is made of a conductive material and is located upstream or downstream in a transfer belt rotating direction from a nip portion between the opposing photosensitive drum and the transfer belt.

2. The image forming apparatus according to claim 1,
wherein all the transfer members are made of a conductive material; and
wherein a high-voltage source applies a transfer bias voltage to all the transfer members.

3. The image forming apparatus according to claim 1, wherein the conductive transfer member comprises a roller which is in contact with the transfer belt, the roller being made of conductive metal or conductive resin.

4. The image forming apparatus according to claim 1, wherein the conductive transfer member comprises a conductive film which is in contact with the transfer belt.

5. The image forming apparatus according to claim 1, further comprising:
an adjusting mechanism for adjusting a wind of the transfer belt around the conductive transfer member or the photosensitive drum located opposite the conductive transfer member; and
a control section for controlling the adjusting mechanism to adjust the wind of the transfer belt in accordance with at least an environmental condition or a kind of transfer medium.

6. The image forming apparatus according to claim 1, further comprising:
a pressure adjusting mechanism for adjusting a pressure of the conductive transfer member onto the transfer belt; and
a control section for controlling the pressure adjusting mechanism to adjust the pressure of the conductive transfer member in accordance with at least an environmental condition or a kind of transfer medium.

7. The image forming apparatus according to claim 6, wherein the pressure adjusting mechanism comprises a spring member for elastically pushing the conductive transfer member and an adjusting member for adjusting a spring force of the spring member.

8. The image forming apparatus according to claim 6, wherein the pressure adjusting mechanism adjusts the pressure of the conductive transfer member onto the transfer belt to a plural number of levels.

9. The image forming apparatus according to claim 6, wherein the pressure adjusting mechanism is capable of moving the conductive transfer member to a position to make the transfer belt separate from the photosensitive drum located opposite the conductive transfer member.

10. The image forming apparatus according to claim 1, further comprising:
a tension adjusting mechanism for adjusting a tension of the transfer belt; and
a control section for controlling the tension adjusting mechanism to adjust the tension of the transfer belt in accordance with at least an environmental condition or a kind of transfer medium.

11. The image forming apparatus according to claim 10, wherein the tension adjusting mechanism comprises a spring member for elastically pushing a roller holding the transfer belt and an adjusting member for adjusting a spring force of the spring member.
